(19) United States
(12) Patent Application Publication
(10) Pub. No.: US 2026/0107876 A1
(43) Pub. Date: Apr. 23, 2026

(54) Reino-Shield

(71) Applicant: Clay Martin Reinoehl, Decatur, AL (US)

(72) Inventor: Clay Martin Reinoehl, Decatur, AL (US)

(21) Appl. No.: 18/921,912

(22) Filed: Oct. 21, 2024

(51) Int. Cl. A01D 11/00

(52) U.S. Cl. CPC A01D 11/00

(57) ABSTRACT

A protective shield comprising of a section of sheet metal with a fixed carrying handle attached and stabilizer rod that penetrates the ground surface enabling the shield to stand freely without falling over. The shield provides a protective barrier between weed cutting trimmers and multiple surfaces, thereby preventing engagement of rotating nylon string or fixed blade trimmers from making contact with multiple lawn fixture surfaces such as vinyl, wood, and chain link fencing, siding, astro turf, wood posts, or any other potentially affected lawn fixture surfaces that would otherwise be damaged, stained, or soiled by direct contact with string or fixed blade trimmers.

The construction of the protective shield in FIG. 1 is comprised of 18 GA mild steel sheet metal 102 with two 90° bends 104 and two quarter-round notches in the top 90° bend 106 and one mid stabilizer rod guide hole with a plastic sleeve situated in the center of the top bend 108 and two pieces of round steel tubing (flattened at the bottom) welded onto the sheet metal shield 110 and one lower stabilizer rod guide 112 welded onto the sheet metal shield.

Reference FIG. 2, both pieces of round steel tubing 110 contain a PCV internal coupling 114 that enables connection of the PVC handle risers 116 to the steel tubing 110. The PVC handle risers 116 consist of PVC pipe with steel clevis pins 118 that penetrate through the handle risers 116 and internal couplings 114 thus fastening the PVC handle risers and carrying handle 116 to the steel tubing 110 welded onto the shield.

Reference FIG. 3, stabilizing the Reino-Shield is accomplished by use of a stabilizer rod 120 that is guided with some resistance through the upper 122, mid 108, and lower 112 stabilizer rod guides thereby allowing the operator to move the stabilizer rod 120 in a downward motion in order to penetrate the ground surface and stabilize the shield as needed, then retract the rod to the home position. The stabilizer rod 120 consists of round mild steel with a plastic grab handle fixed to a 90° bend section at the of the rod.

The shield 102, round steel tubing 110, PVC handle apparatus 116, and stabilizer rod 120 are coated with enamal paint but can also be coated with power coating or chemical treating process.

### BRIEF DESCRIPTION OF DRAWINGS

FIG. 1 is a front view of the sheet metal shield 102 showing two 90° bends 104, two notches in the top 90° bend 106, a mid stabilizer rod guide hole 108, two pieces of round steel tubing 110, and a lower stabilizer rod guide 112.

FIG. 2 is a front view showing two PCV internal couplings 114 with clevis pins 118 that connect two PVC handle risers 116 and carrying handle 116 to round steel tubing 110.

FIG. 3 is a front view showing the stabilizer rod 120 guided through and supported by upper 122, mid 108, and lower 112 stabilizer rod guides.

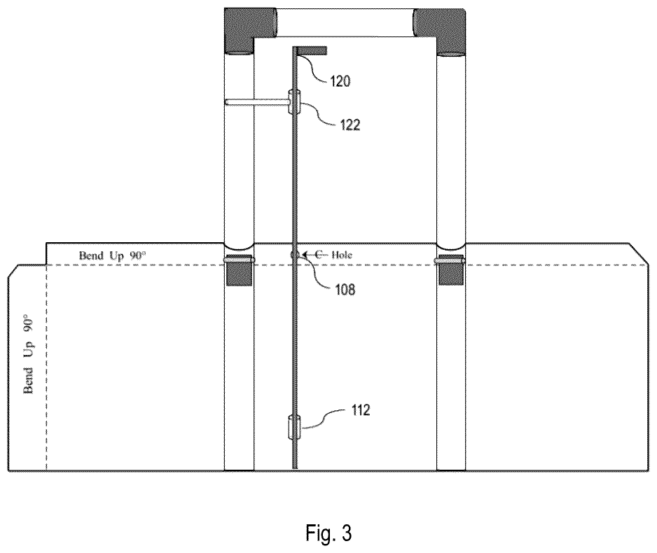

FIG. 4 is a front view showing the Reino-Shield in it's entirety with all of it's components, dimensions, and reference numbers 102-122.

### DETAILED DESCRIPTION OF THE INVENTION

Reino-Shield is a protective shield that protects yard surfaces from string and fixed blade trimmer damage, stains and grime buildup. The invention consists of 18 GA steel sheet metal 102 with two 90° bends 104 and two quarter-round notches in the top 90° bend 106 and two pieces of round steel tubing welded onto the shield 110 containing two internal PVC couplings 114 with clevis pins 118 that connect two PVC pipe risers 116 with two 90° elbows that connect a horizontal PVC handle 116 which is used to carry and operate the shield effectively.

The shield also incorporates a stabilizer rod 120 which is guided in a down and up motion through upper 122, mid 108, and lower 112 stabilizer rod guides that serve the purpose of stabilizing the shield when placed against a fence panel or any other surface to be protected. In addition, the stabilizer rod 120 enables the shield 102 to freely stand on its own; for example, when needing to trim along a low-surface concrete patio deck lined with astro turf, the shield does not need to lean on a backing surface to be able to stabilize and thus freely stand on it own.

Reino-Shield is designed to be carried along via the carrying handle apparatus 116 and used as a protective shield 102 for trimming along residential, commercial or industrial fence perimeters or any fixed surface areas that require the elimination of overgrown and unsightly weeds or grass and wish to do so with care, protection, and clean surface results when using string and fixed blade yard trimmers to trim weeds that reside up against, on, and along fencing, posts, siding, astro turf, gutter spouts, garden perimeters or any other fixed landscaping surface in need of protection from trimmer damage, stains, and grime buildup thus leaving behind professional and clean-looking yard trimming results.

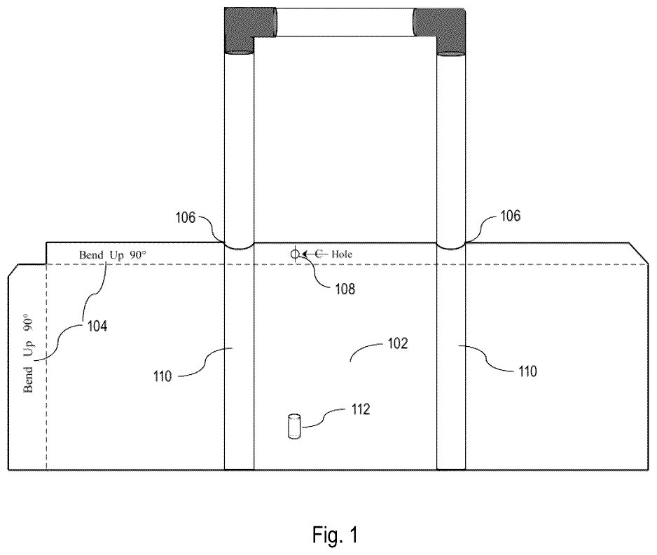

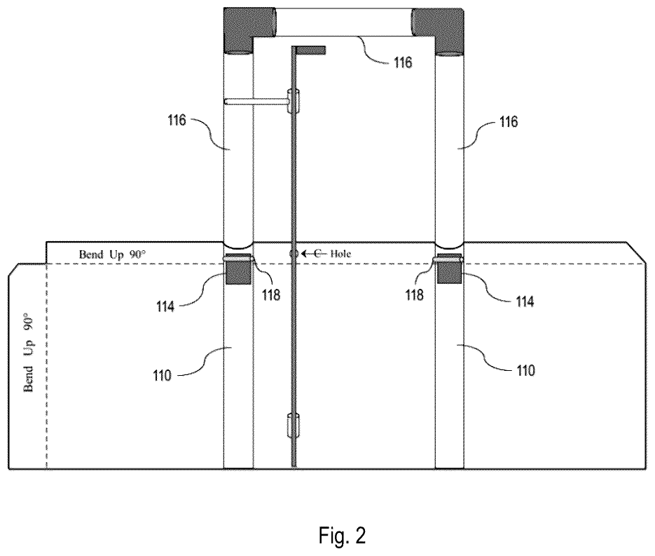

1. Reference FIG. 1 and FIG. 2, the protective shield 102 and carrying handle apparatus 116 pursuant to this claim shall cover any form of protective shield used in the same manner such as to utilize the method of carrying a handheld shield that protects against nylon string and fixed blade yard trimmers from damage, stains, and buildup of dirt and grime that would otherwise happen without the claimed novel invention that is Reino-Shield.

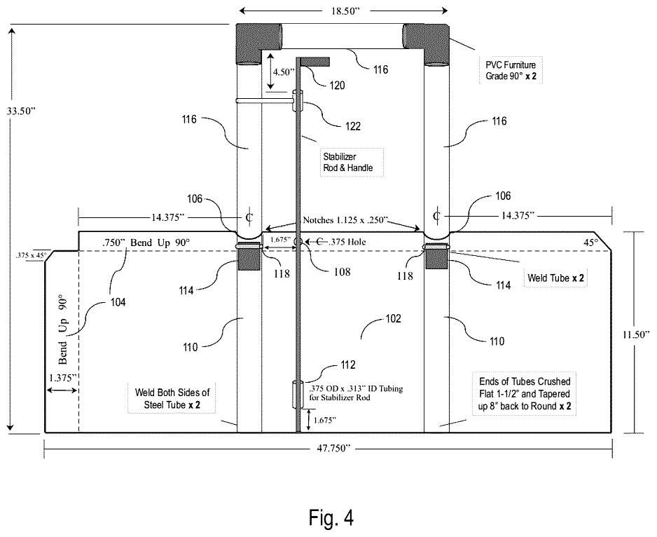

2. Reference FIG. 4, the entire novel invention with all of its components and dimensions (shield, bends for rigidity, stabilizer rod to enable free standing of the shield, PVC handle to carry and operate the shield) shall not be duplicated in any way pursuant to the entire invention in such a manner to utilize this type or form of protection that shields against nylon string and fixed blade motorized yard trimmers from damage, stains, and buildup of dirt and grime that would otherwise occur without the use of this claimed invention, Reino-Shield, and shall not be duplicated in any way, shape, or form without the sole permission and/or licensing of the inventor that is Reino-Shield, LLC named in the enclosed claims herein.
